(19) United States
(12) Patent Application Publication
(10) Pub. No.: US 2012/0084917 A1
(43) Pub. Date: Apr. 12, 2012

(54) Infant Seat Carrier Blanket

(75) Inventor: Brett Wiggins, Diamond Bar, CA (US)

(73) Assignee: WIGGY CO., LLC, Diamond Bar, CA (US)

(21) Appl. No.: 13/267,226

(22) Filed: Oct. 6, 2011

Related U.S. Application Data
(60) Provisional application No. 61/404,820, filed on Oct. 8, 2010.

(51) Int. Cl. A47G 9/02; B23P 11/00; A47G 9/04

(52) U.S. Cl. 5/482; 29/428

(57) ABSTRACT

A blanket formed from a main section and an auxiliary section sharing a common interface. The main section including a center section disposed between a pair of side panels that extend beyond the auxiliary section and are foldable inward toward the center section. In a fully stored rolled up state a storage flap keeps the blanket compactly secured and portable. The blanket is installed on the infant seat carrier by passing a safety strap in the auxiliary section through a loop of the safety harness between the infant's legs. While remaining installed on the infant carrier seat the blanket may be unrolled and unfolded to cover the infant. Without having to remove the blanket from the infant seat carrier or disturb an infant therein, the side panels may be folded inward and rolled up to a partially stored rolled up state beneath the infant's legs.

### CROSS-REFERENCE TO RELATED APPLICATION

This application claims the benefit of U.S. Provisional Application No. 61/404,820, filed Oct. 8, 2010, which is herein incorporated by reference in its entirety.

### BACKGROUND OF THE INVENTION

1. Field of the Invention

The present invention relates to a blanket for use with an infant carrier seat. In particular, the invention is directed to a blanket that may be used other than with the infant seat carrier, but also serves the dual purpose of being releasably securable to the infant seat carrier and able to be stored partially stored rolled up and out of the way beneath the legs of the infant without having to remove or disturb the infant therein.

2. Description of Related Art

Today most infants are transported in carrier seats. Some infant carrier seats are multi-functional in that they may be utilized in any one or more uses such as alone for transporting an infant while being carried by hand or over the arm, as a car seat when strapped into a vehicle and/or forming the body of a stroller when assembled to a base with wheels. Regardless of whether the carrier seat serves only one or more than one function, it is desirable to have a blanket readily accessible to cover the infant while they are supported in the carrier seat.

Any person having to care for an infant recognizes the desirability of having certain items that are easily accessible even when having only one hand free. Another feature that is coveted by most caregivers of infant children is the ability to have any necessity item in a portable, compact form that may be secured to another essential item thereby eliminating having to remember to take it with you.

It is therefore desirable to develop an improved infant seat carrier blanket that incorporates all these desirable features.

### SUMMARY OF THE INVENTION

An aspect of present invention is an improved infant seat carrier blanket that is portable and compact while easily securing to any infant seat carrier.

Another aspect of the present invention is an improved infant seat carrier blanket that may be fully stored rolled up so as to be portable and compact for use other than with an infant seat carrier.

Still another aspect of the present invention is an improved infant seat carrier blanket that is securely installed on an infant seat carrier when covering the infant seated therein.

Yet another aspect of the present invention is an improved infant seat carrier blanket that is easily folded and rolled in a partially stored rolled up state out of the way without having to remove the blanket from the infant seat carrier or disturb the infant seat therein.

An embodiment of the present invention is directed to a blanket for an infant seat carrier wherein the blanket is formed from a main section and an auxiliary section sharing a common interface. The main section includes a center section sandwiched between a pair of side panels that extend beyond the auxiliary section and are foldable inward toward the center section. In a fully stored rolled up state a storage flap keeps the blanket compactly secured and portable. The blanket is installed on the infant seat carrier by passing a safety strap in the auxiliary section through a loop of the safety harness between the infant's legs. While remaining installed on the infant carrier seat the blanket may be unrolled and unfolded to cover the infant. Without having to remove the blanket from the infant seat carrier or disturb an infant therein, the side panels may be folded inward and rolled up to a partially stored rolled up state beneath the infant's legs.

One particular embodiment of the present invention is directed to a blanket having a front surface and an opposite back surface. The blanket includes a main section having a longitudinal axis and a lateral axis. In a direction along the longitudinal axis, the main section has a free terminating end and an opposite end. The main section having a predetermined length in a direction along the lateral axis. Aside from the main section, the blanket also has an auxiliary section having a longitudinal axis and a lateral axis. In a direction along the longitudinal axis, the auxiliary section has a free terminating end and an opposite end. Opposite ends of the main and auxiliary sections share a common interface. The predetermined length in a direction along the lateral axis of the main section being greater than a predetermined length along the lateral axis of the auxiliary section; the auxiliary section having an opening defined therein.

Another embodiment is directed to a blanket as described in the preceding paragraph also having a storage flap having a first end and a second end both secured to the front surface of the blanket. The first end of the storage flap is attached to the auxiliary section on the front surface of the blanket, while the second end of the storage flap is releasably secured by a first releasable securing mechanism on the center panel of the main section on the front surface of the blanket. Wherein the first releasable securing mechanism is located on the center panel at a distance extending in a direction along the longitudinal axis starting from where the first end of the storage flap is secured to the auxiliary section that is substantially equal to a predetermined width of the storage flap in a direction along the longitudinal axis. The auxiliary section includes a safety strap having a pair of lateral sides substantially parallel to the lateral axis, a first end and an opposite second end. One of the lateral sides forming at least a portion of the free terminating end of the auxiliary section while the other lateral side defining a portion of a perimeter of the opening. The main section includes a center panel that substantially coincides with the auxiliary section in a direction along the lateral axis; and a pair of side panels with the center panel sandwiched therebetween in the direction along the lateral axis. A predetermined length of each of the side panels in the direction along the lateral axis is less than or equal to a predetermined length of the center panel in the direction along the lateral axis. The blanket further includes a second releasable securing mechanism secured to the auxiliary section between the opening and the first end of the storage flap on the front surface of the blanket. The second releasable securing mechanism is adapted to secure the second end of the storage flap while in a fully stored rolled up state with the pair of side panels folded inward in a direction along the lateral axis toward the center panel and the blanket rolled up starting from the free terminating end of the main section to the free terminating end of the auxiliary section. A third releasable securing mechanism is secured to the auxiliary section on the back surface of the blanket and substantially coinciding in location with the second releasable securing mechanism. The third releasable securing mechanism is adapted to secure the second end of the storage flap while in a partially stored rolled up state with the pair of side panels folded inward in a direction along the lateral axis toward the center panel and the blanket rolled up starting from the free terminating end of the main section toward the common interface with the auxiliary section, while at least a portion of the auxiliary section remains unrolled. A fourth releasable securing mechanism is disposed on the auxiliary section, the second end of the safety strap being releasably secured to the fourth releasable securing mechanism. In addition, a pair of fifth releasable securing mechanisms is disposed proximate corners of the main section.

Still another embodiment of the present invention is directed to a method for installing on an infant carrier seat having a safety crotch harness a blanket as described in one of the preceding paragraphs. Initially, the second end of the storage flap is released from the first releasable securing mechanism. The auxiliary and main sections of the blanket are then unrolled. Thereafter, the side panels are unfolded outward from the center panel in the direction along the lateral axis of the main section. The safety strap is then secured through the safety crotch harness of the infant carrier seat to a fourth releasable securing mechanism attached to the auxiliary section. While remaining secured through the safety crotch harness, the blanked may be partially rolled when not in use. This is accomplished by folding the side panels inward toward the center panel in the direction along the lateral axis. Then the main section of the blanket is partially rolled up starting from the free terminating end towards the common interface with the auxiliary section, while at least a portion of the auxiliary section remains unrolled with the safety strap remaining secured through the safety crotch harness of the infant carrier seat. The second end of the storage flap is secured to the third releasable securing mechanism attached to the auxiliary section on the back surface of the blanket to store the blanket in a partially stored rolled up state without having to uninstall the blanket from the infant seat carrier.

Yet another embodiment of the present invention is directed to a method for storing the blanket in a rolled state when not secured to the safety crotch harness of the infant carrier seat. The blanket is stored compactly by folding the side panels inward toward the center panel in the direction along the lateral axis of the main section. Then, the main section of the blanket is fully rolled up starting from the free terminating end of the main section to the free terminating end of the auxiliary section. In order to prevent the blanket from unwinding, the second end of the storage flap is secured to the second releasable securing mechanism.

### BRIEF DESCRIPTION OF THE DRAWING

The foregoing and other features of the present invention will be more readily apparent from the following detailed description and drawings of illustrative embodiments of the invention wherein like reference numbers refer to similar elements throughout the several views and in which:

FIG. 1 is an exemplary front view of the infant seat carrier blanket in accordance with the present invention in its unrolled-unfolded state;

FIG. 2 is the back view of the infant seat carrier blanket of FIG. 1 while in its unrolled-unfolded state;

FIG. 3 is a side view of the infant seat carrier blanket of FIG. 1;

FIG. 4 is a perspective view of the infant seat carrier blanket of FIG. 1 with the side panels folded inward laterally toward the center panel as it is being rolled;

FIG. 5 is a perspective view of the infant seat carrier blanket of FIG. 1 in a partially stored rolled up state with the side panels folded inward laterally toward the center panel and the main section rolled up and secured by the storage flap with a portion of the auxiliary section unrolled;

FIG. 6 is perspective view of the infant seat carrier blanket of FIG. 1 in a fully stored rolled up state with the side panels folded inward laterally toward the center panel and the main and auxiliary sections rolled up;

FIG. 7 depicts the infant seat carrier blanket of FIG. 1 in an unrolled-unfolded state installed on an infant seat carrier with the safety strap secured through the safety crotch harness of the infant seat carrier; and

FIG. 8 depicts the infant seat carrier blanket of FIG. 1 in a partially stored rolled up state out of the way beneath the infant's legs while remaining installed on a different type of infant seat than that depicted in FIG. 7.

### DETAILED DESCRIPTION OF THE INVENTION

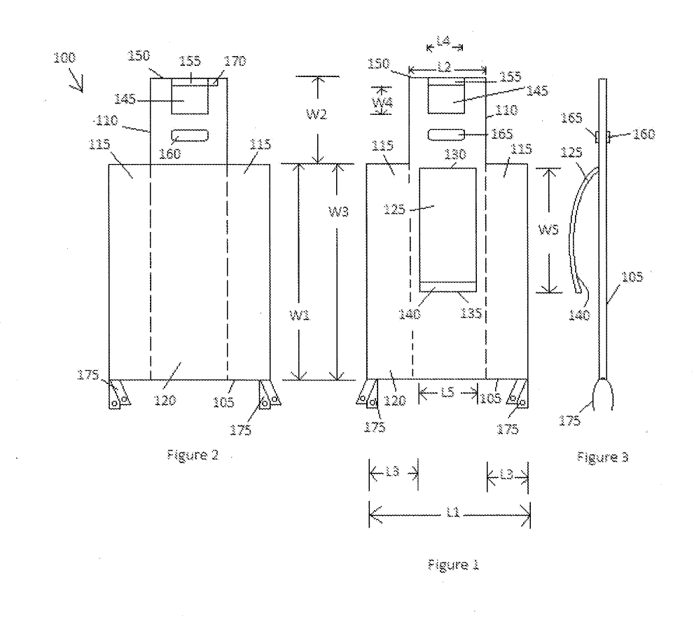

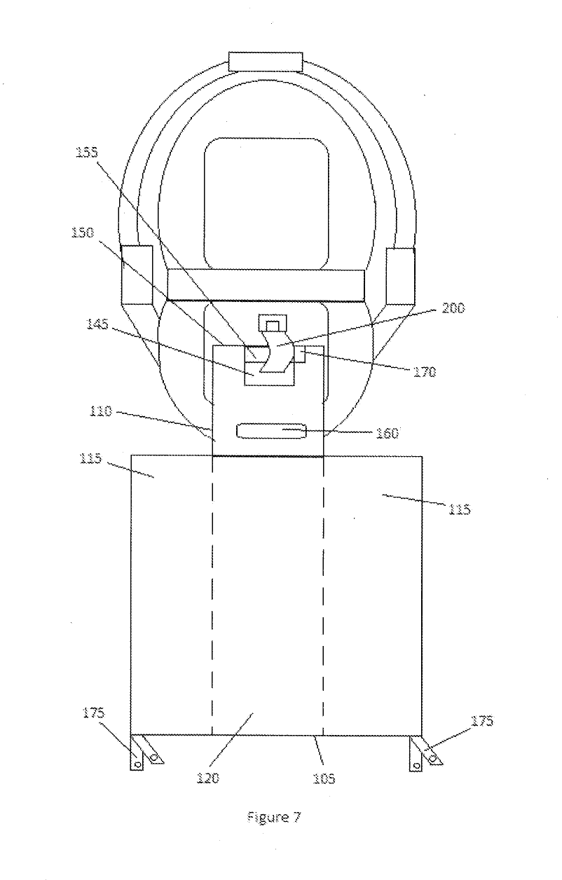

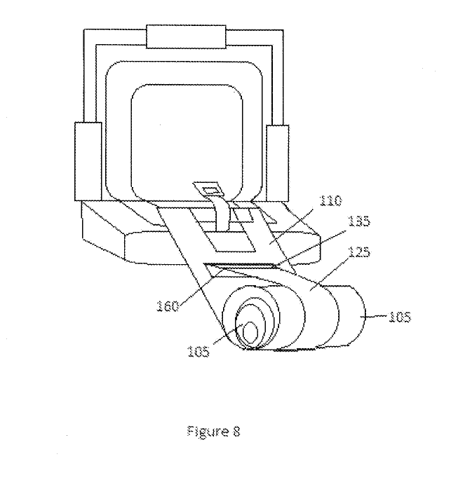

The present inventive blanket may be utilized with any type of infant carrier seat or other device that has at least one safety crotch strap or harness that extends between the legs of the infant. The design or configuration of the infant carrier seat depicted throughout the drawings is for illustrative purpose only and in no way intended to limit in scope the present claimed invention. For instance, the present invention is equally applicable to a 5-point or 3-point safety harness (as shown in FIG. 7). Moreover, as discussed in detail below, the present inventive blanket during use may, but need not be, secured to the infant seat carrier. Referring to FIG. 1 the infant seat carrier blanket 100 may be made of any desired material or fabric that may be rolled. Preferably the blanket is made from a soft washable material or fabric such as fleece. As is readily seen while in an unrolled state, as depicted in FIGS. 1 and 2, the infant seat carrier blanket 100 comprises two sections: a main section 105 and an auxiliary section 110. An opening 145 is preferably defined in auxiliary section 110 that serves multiple functions such as (i) permitting access to a belt length adjustment mechanism of the infant seat carrier; and/or (ii) providing the best fit by accommodating for movement of the blanket when either in a partially stored rolled up state or unrolled state. In a preferred embodiment, opening 115 is rectangular in shape, however, other shapes (e.g., square, oval, circle) are contemplated and within the intended scope of the invention so long as the auxiliary section 110 of the infant seat carrier blanket does not obstruct visually and/or operationally the belt length adjustment mechanism.

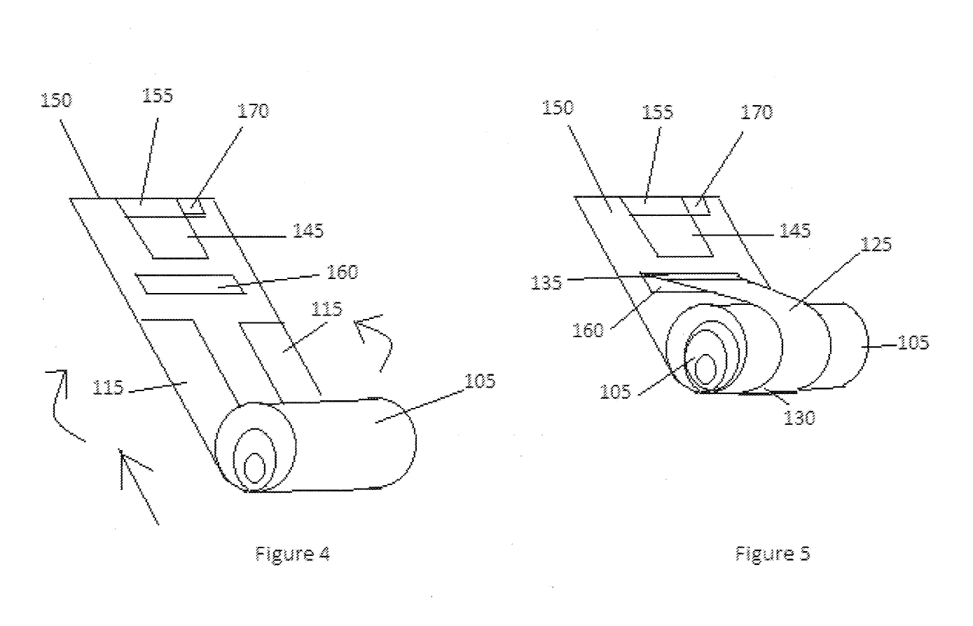

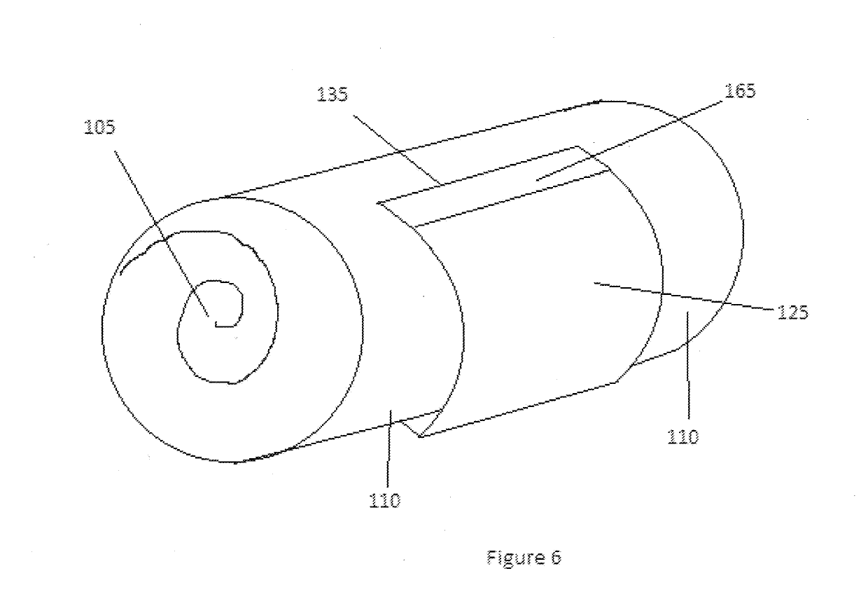

By way of illustrative example, sections 105, 110 are depicted throughout the figures as being formed from a single integral piece of material or fabric. Alternatively, each of sections 105, 110 may be formed from a separate piece of material or fabric secured together. Moreover, any one section 105, 110 may itself be formed from more than one piece of material or fabric secured together, for example, sewn together, without departing from the scope of the present invention. Referring to FIG. 1, main section 105 is substantially square, whereby its length (L1) in a lateral direction and width (W1) in a longitudinal direction is substantially equal. Auxiliary section 110 has a rectangular shape with its length (L2) in a lateral direction shorter than its width (W2) in a longitudinal direction. The shape of main and auxiliary sections 105, 110 may be varied, as desired, so long as the length L1 of the main section 105 is greater than the length L2 of the auxiliary section 110. Those opposing portions of the main section 105 that extend beyond that of the auxiliary section 110 are hereinafter referred to as side panels 115. Throughout the drawings side panels 115 are substantially equal in length (L3), however, they may alternatively differ in length. The length of L3 of any side panel is substantially equal to or less than the length L2 of auxiliary section 110, the length L3 is less than the length L2. In one example, L3+L3≦L2. A further example, L1=L2+L3+L3. As depicted in FIG. 4, side panels 115 fold laterally inward on to a center panel 120 of the main section 105. It should be noted that the shape of the main and auxiliary sections may be varied, as desired, such as, but not limited to, square, rectangular, circular or oval. The only limiting factor is that the side panels 115 of the main section 105 extend laterally beyond the length of the auxiliary section 110 so that the side panels 115 may be laterally folded on to the center panel 120. Furthermore, the shape of the main section 105 may be the same or differ from that of the auxiliary section 110. It is also preferable that the length L1 of the main section 105 is selected so that when in use the blanket tucks neatly into the infant seat carrier without minimal, if any, overhang.

Auxiliary section 110 has a single longitudinal free end 150 and an opening 145 defined therein. A portion of the free end 150 coinciding with the opening 145 forms a safety strap or flap 155 with one end secured to auxiliary section 110 and a free end of the safety strap 155 releasably secured to the auxiliary section by a releasable securing mechanism 170. Safety strap 155 may be separate from or integral with the auxiliary section 110. Furthermore, the material used to form the safety strap 155 may be the same or different from that used for the auxiliary section 110.

As is clearly illustrated in the side view in FIG. 3, a tongue, storage flap or strap 125 is secured at one end 130 to the auxiliary section 110 between the opening 145 and an interface of the main/auxiliary sections 105, 110. Its opposite free end 135 is releasably secured to the center panel 120 by a first releasable securing mechanism 140 mounted to the center panel 120 on the same side of the blanket 100 as the secured end 130 of the storage flap or strap 125. The first releasable securing mechanism 140 secures the storage flap or strap 125 proximate the main section 105 and out of the way while the blanket is in an unrolled-unfolded state. Accordingly, the first releasable securing mechanism 140 is displaced relative to the secured end 130 a distance approximately equal to a longitudinal length of the storage flap 125. To prevent loss of the storage flap or strap 125, end 130 of the storage flap or strap 125 is preferably permanently secured or affixed to the auxiliary section 110. Alternatively, end 130 of the storage flap or strap 125 may be releasably secured by another releasable securing mechanism that is either the same or different from that of the first releasable securing mechanism 140 used to secure the opposite free end 135. For instance, the releasable securing mechanism may be hook-and-loop, hook-and-eye, snaps, zipper, buckle or lacing. In this alternative embodiment, the storage flap or strap 125 may be removed from the blanket when in an unrolled-unfolded state.

A second releasable securing mechanism 165 is mounted to the same front side or surface of the blanket 100 as the first releasable securing mechanism 140. Unlike the first releasable securing mechanism 140 that is disposed on the center panel 120 of the main section 105, the second releasable securing mechanism is located in auxiliary section 110 between the opening 145 and the affixed end 130 of the storage flap 130. When not installed on an infant carrier seat, the blanket with the side panels 115 folded laterally inward toward the center panel 120 may be fully stored rolled up starting with the longitudinal free end of the main section 105 until reaching the longitudinal free end of the auxiliary section 110. Once in the fully stored rolled up state the free end 135 of the storage flap 125 may be secured to the second releasable securing mechanism 165 to keep the blanket from unraveling.

A back side or surface of the blanket 100, as shown in FIG. 2, has a third releasable securing mechanism 160 attached thereto for maintaining the blanket in a partially stored rolled up state (i.e., the main section 105 is in a rolled up state, while at least a portion of the auxiliary section remains in an unrolled stated) when installed on the infant carrier seat. In a preferred embodiment, the second and third releasable securing mechanisms 160, 165, respectively, are disposed in substantially the same location on opposite sides or surfaces (front side vs. back side) of the blanket.

To install the blanket on the infant carrier seat, starting from a fully stored rolled up state, the free end 135 of the storage flap or strap 125 is released from the second releasable securing mechanism 165. The blanket is free to be unrolled longitudinally. Side panels 115 are unfolded laterally outward from the center panel 120 so that the blanket is now in an unrolled-unfolded state. In an unrolled-unfolded state, the free end 135 of storage flap or strap 125 is facing downward and may be secured to the first releasable securing mechanism 140 so that it is out of the way when using the blanket. One or more, preferably a pair, of snap ties or any other fifth releasable securing mechanism 175 may be mounted proximate the corners of the free edge of the longitudinal side. The snap ties secure the blanket to handles of the infant car seat carrier when the blanket is unrolled-unfolded so as to insure that the blanket is not blown off or removed by the infant.

While in an unrolled-unfolded state, once released from the third releasable securing mechanism 170, the free end of the safety strap 155 is inserted through a safety crotch harness or strap 200 of the infant seat carrier extending upwards between the legs of the infant (as depicted in FIG. 7). At any point in time, regardless of whether the blanket is in a partially stored rolled up state or an unrolled-unfolded state, safety strap 155 may be removed from the infant seat carrier without having to release the infant seat carrier safety harness/strap or disturb the infant seated therein. In the unrolled-unfolded state, the blanket may be tucked in around the infant while seated in the carrier. While remaining secured to the infant seat carrier by the safety strap 155, the blanket 100 when no longer in use may be rolled to a partially stored rolled up state starting from a longitudinal free end of the main section 105 until reaching substantially the main/auxiliary section interface. In this partially stored rolled up state, the free end 135 of the storage flap 125 may be secured to the third releasable securing mechanism 160 to keep the blanket stored securely out of the way beneath the infant's legs yet remain easily accessible, as depicted in FIG. 8.

When the safety strap 155 has been released from the fourth releasable securing mechanism 170, the blanket may be removed from the infant seat carrier and stored in its compact fully stored rolled up state. If the blanket when removed from the infant seat carrier is currently in the partially stored rolled up state then the free end 135 of the storage flap 125 is released from the third releasable securing mechanism 160. Thereafter, the auxiliary section 110 is wound about the partially stored rolled up main section 105. Once the entire blanket has been rolled up into its fully stored rolled up state, the free end of 135 of the storage flap 125 is secured to the second releasable securing mechanism 165. Otherwise, if the blanket when removed from the infant seat carrier is currently in an unrolled-unfolded state, then the side panels 115 are folded inward toward the center panel 120. Starting from the longitudinal free end of the main section 105 the blanket is rolled up until reaching the longitudinal free end of the auxiliary section 105. In this fully stored rolled up state, the free end 135 of the storage flap 125 is then secured to the second releasable securing mechanism 165. It is evident, that in the fully stored rolled up state, the blanket may be easily stored in a diaper bag, drawer or other location, ready for use.

By way of illustrative example, an exemplary infant carrier seat in accordance with the present invention is made of fleece, wherein all of the releasable securing mechanisms are hook-and-loop. The blanket has the following dimensional ranges:

Main Section: Length (L1) [approximately 17 inches-approximately 20 inches]×Width (W1) [approximately 16 inches-approximately 20 inches]

Auxiliary Section: Length (L2) [approximately 8.5 inches-approximately 9 inches]×Width (W2) [approximately 10 inches-approximately 11 inches]

Each Side Panel: Length (L3) [approximately 4 inches-approximately 5.75 inches]×Width (W3) [approximately 16 inches-approximately 20 inches]

Storage Flap: Length (L5) [approximately 4.5 inches]×Width (W5) [approximately 9 inches]

Opening: Length (L4) [approximately 2.5 inches-approximately 3.5 inches]×Width (W4) [approximately 2.5 inches-approximately 3.0 inches]

In the illustrative example, the second and third releasable securing mechanisms are disposed at substantially the same location on opposite sides of the blanket (front side and back side). Specifically, the second and third releasable securing mechanisms in the illustrative example are substantially centered on the auxiliary section 110 located approximately 2.25 inches-approximately 2.5 inches from the lateral edges of the auxiliary section and approximately 6 inches-approximately 6.5 inches from the longitudinal free end of the auxiliary section.

When installed on the infant carrier seat, the present invention while in an unrolled-unfolded state outstretched in front of the carrier seat serves a dual function of serving as a diaper changing mat. If such dual function is desired, the fabric or material is preferably treated with a non-absorbent coating. It is also the case that the present inventive blanket may be used as a pillow when in either the partially or fully stored rolled up state.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

Every issued patent, pending patent application, publication, journal article, book or any other reference cited herein is each incorporated by reference in their entirety.

What is claimed is:

1. A blanket having a front surface and an opposite back surface comprising:
a main section having a longitudinal axis and a lateral axis; the main section having a free terminating end and an opposite end in a direction along the longitudinal axis; and the main section having a predetermined length in a direction along the lateral axis; and
an auxiliary section having a longitudinal axis and a lateral axis; the auxiliary section having a free terminating end and an opposite end in a direction along the longitudinal axis, the opposite ends of the main and auxiliary sections sharing a common interface; the predetermined length in a direction along the lateral axis of the main section being greater than a predetermined length along the lateral axis of the auxiliary section; the auxiliary section having an opening defined therein.

2. The blanket in accordance with claim 1, further comprising:
a storage flap having a first end and a second end both secured to the front surface of the blanket; the first end of the storage flap is attached to the auxiliary section on the front surface of the blanket, while the second end of the storage flap is releasably secured by a first releasable securing mechanism on the main section on the front surface of the blanket.

3. The blanket in accordance with claim 1, wherein the auxiliary section includes a safety strap releasably secured at least at one end to the auxiliary section and forming at least a portion of a perimeter of the opening defined in the auxiliary section.

4. The blanket in accordance with claim 3, wherein the safety strap has a pair of sides substantially parallel to the lateral axis of the auxiliary section, one side of the safety strap forming at least a portion of the free terminating end of the auxiliary section; the safety strap having a first end and an opposite second end.

5. The blanket in accordance with claim 1, wherein the main section includes a center panel and a pair of side panels with the center panel disposed therebetween in the direction along the lateral axis of the main section.

6. The blanket in accordance with claim 5, wherein the center panel substantially coincides with the auxiliary section in a direction along the lateral axis of the main section.

7. The blanket in accordance with claim 5, wherein a predetermined length of each of the side panels in the direction along the lateral axis of the main section is less than or equal to a predetermined length of the center panel in the direction along the lateral axis of the main section.

8. The blanket in accordance with claim 2, wherein the main section includes a center panel and a pair of side panels with the center panel disposed therebetween in the direction along the lateral axis of the main section.

9. The blanket in accordance with claim 8, further comprising a second releasable securing mechanism secured to the auxiliary section between the opening and the first end of the storage flap on the front surface of the blanket; the second releasable securing mechanism adapted to secure the second end of the storage flap while in a fully stored rolled up state with the pair of side panels folded inward in a direction along the lateral axis toward the center panel and the blanket rolled up starting from the free terminating end of the main section to the free terminating end of the auxiliary section.

10. The blanket in accordance with claim 9, further comprising a third releasable securing mechanism secured to the auxiliary section on the back surface of the blanket and substantially coinciding in location with the second releasable securing mechanism; the third releasable securing mechanism adapted to secure the second end of the storage flap while in a partially stored rolled up state with the pair of side panels folded inward in a direction along the lateral axis toward the center panel and the blanket rolled up starting from the free terminating end of the main section toward the common interface with the auxiliary section, while at least a portion of the auxiliary section remains unrolled.

11. The blanket in accordance with claim 3, further comprising a fourth releasable securing mechanism disposed on the auxiliary section, the second end of the safety strap being releasably secured to the fourth releasable securing mechanism.

12. The blanket in accordance with claim 1, further comprising a pair of fifth releasable securing mechanisms disposed proximate corners of the main section.

13. The blanket in accordance with claim 1, further comprising:
a storage flap having a first end and a second end both secured to the front surface of the blanket; the first end of the storage flap is attached to the auxiliary section on the front surface of the blanket, while the second end of the storage flap is releasably secured by a first releasable securing mechanism on the main section on the front surface of the blanket;
the auxiliary section including a safety strap having a pair of lateral sides substantially parallel to the lateral axis of the auxiliary section, one lateral side of the safety strap forming at least a portion of the free terminating end of the auxiliary section while the other lateral side defining a portion of a perimeter of the opening; the safety strap having a first end and an opposite second end; and
the main section including a center panel that coincides with the auxiliary section in a direction along the lateral axis of the main section; the main section further comprises a pair of side panels with the center panel sandwiched therebetween in the direction along the lateral axis of the main section; wherein a predetermined length of each of the side panels in the direction along the lateral axis of the main section is less than or equal to a predetermined length of the center panel in the direction along the lateral axis of the main section.

14. The blanket in accordance with claim 1, further comprising:
a storage flap having a first end and a second end both secured to the front surface of the blanket; the first end of the storage flap is attached to the auxiliary section on the front surface of the blanket, while the second end of the storage flap is releasably secured by a first releasable securing mechanism on the main section on the front surface of the blanket;
the main section including a center panel that coincides with the auxiliary section in a direction along the lateral axis of the main section; the main section further comprises a pair of side panels with the center panel sandwiched therebetween in the direction along the lateral axis of the main section; wherein a predetermined length of each of the side panels in the direction along the lateral axis of the main section is less than or equal to a predetermined length of the center panel in the direction along the lateral axis of the main section; and
a second releasable securing mechanism secured to the auxiliary section between the opening and the first end of the storage flap on the front surface of the blanket; the second releasable securing mechanism adapted to secure the second end of the storage flap while in a fully stored rolled up state with the pair of side panels folded inward in a direction along the lateral axis toward the center panel and the blanket rolled up starting from the free terminating end of the main section to the free terminating end of the auxiliary section.

15. A method for installing on an infant carrier seat having a safety crotch harness a blanket in accordance with claim 13, the method comprising the steps of:
releasing the second end of the storage flap from the first releasable securing mechanism;
unrolling the auxiliary and main sections of the blanket;
unfolding the side panels outward from the center panel in the direction along the lateral axis of the main section; and
securing the safety strap through the safety crotch harness of the infant carrier seat to a fourth releasable securing mechanism attached to the auxiliary section.

16. The method in accordance with claim 15, further comprising the steps of:
folding the side panels inward toward the center panel in the direction along the lateral axis;
partially rolling up the main section of the blanket starting from the free terminating end towards the common interface with the auxiliary section, while at least a portion of the auxiliary section remains unrolled with the safety strap remaining secured through the safety crotch harness of the infant carrier seat; and
when the blanket is not in use, securing the second end of the storage flap to the third releasable securing mechanism attached to the auxiliary section on the back surface of the blanket to store the blanket in a partially stored rolled up state without having to uninstall the blanket from the infant seat carrier.

17. The method in accordance with claim 16, wherein the blanket is adapted to be partially rolled and unrolled while remaining secured through the safety crotch harness of the infant carrier seat via the safety strap.

18. A method for storing the blanket in accordance with claim 14 in a rolled state, comprising the steps of:
folding the side panels inward toward the center panel in the direction along the lateral axis of the main section;
rolling up the main section of the blanket fully starting from the free terminating end of the main section to the free terminating end of the auxiliary section; and
securing the second end of the storage flap to the second releasable securing mechanism to maintain the blanket in a fully stored rolled up state.

19. A blanket having a front surface and an opposite back surface comprising:
a main section having a longitudinal axis and a lateral axis; the main section having a free terminating end and an opposite end in a direction along the longitudinal axis; and the main section having a predetermined length in a direction along the lateral axis; and
an auxiliary section having a longitudinal axis and a lateral axis; the auxiliary section having a free terminating end and an opposite end in a direction along the longitudinal axis, the opposite ends of the main and auxiliary sections sharing a common interface; the predetermined length in a direction along the lateral axis of the main section being greater than a predetermined length along the lateral axis of the auxiliary section; the auxiliary section having an opening defined therein;
a storage flap having a first end and a second end both secured to the front surface of the blanket; the first end of the storage flap is attached to the auxiliary section on the front surface of the blanket, while the second end of the storage flap is releasably secured by a first releasable securing mechanism on the center panel of the main section on the front surface of the blanket; the first releasable securing mechanism located on the center panel at a distance extending in a direction along the longitudinal axis starting from where the first end of the storage flap is secured to the auxiliary section that is substantially equal to a predetermined width of the storage flap in a direction along the longitudinal axis;
the auxiliary section including a safety strap having a pair of lateral sides substantially parallel to the lateral axis, a first end and an opposite second end; one of the lateral sides forming at least a portion of the free terminating end of the auxiliary section while the other lateral side defining a portion of a perimeter of the opening;
the main section comprising a center panel that substantially coincides with the auxiliary section in a direction along the lateral axis; the main section further comprises a pair of side panels with the center panel sandwiched therebetween in the direction along the lateral axis; wherein a predetermined length of each of the side panels in the direction along the lateral axis is less than or equal to a predetermined length of the center panel in the direction along the lateral axis;
a second releasable securing mechanism secured to the auxiliary section between the opening and the first end of the storage flap on the front surface of the blanket; the second releasable securing mechanism adapted to secure the second end of the storage flap while in a fully stored rolled up state with the pair of side panels folded inward in a direction along the lateral axis toward the center panel and the blanket rolled up starting from the free terminating end of the main section to the free terminating end of the auxiliary section;
a third releasable securing mechanism secured to the auxiliary section on the back surface of the blanket and substantially coinciding in location with the second releasable securing mechanism; the third releasable securing mechanism adapted to secure the second end of the storage flap while in a partially stored rolled up state with the pair of side panels folded inward in a direction along the lateral axis toward the center panel and the blanket rolled up starting from the free terminating end of the main section toward the common interface with the auxiliary section, while at least a portion of the auxiliary section remains unrolled;
a fourth releasable securing mechanism disposed on the auxiliary section, the second end of the safety strap being releasably secured to the fourth releasable securing mechanism; and
a pair of fifth releasable securing mechanisms disposed proximate corners of the main section.
